(19) United States
(12) Patent Application Publication
(10) Pub. No.: US 2019/0257408 A1
(43) Pub. Date: Aug. 22, 2019

(54) OIL CONVEYING AND STORAGE DEVICE AND GEARBOX HAVING SUCH AN OIL CONVEYING AND STORAGE DEVICE

(71) Applicant: FLENDER GMBH, Bocholt (DE)

(72) Inventor: Simon Becka, Wesel (DE)

(73) Assignee: FLENDER GMBH, Bocholt (DE)

(21) Appl. No.: 16/280,654

(22) Filed: Feb. 20, 2019

(30) Foreign Application Priority Data
Feb. 21, 2018 (EP) 18157884.0

(51) Int. Cl. F16H 57/04

(52) U.S. Cl. CPC F16H 57/0447; F16H 57/0424; F16H 57/0441; F16H 57/0457; F16H 57/0439; F16H 57/0452

(57) ABSTRACT

An oil conveying and storage device for reducing an oil level in an oil sump of a gearbox during operation of the gearbox includes a first piston mounted for executing a forward and backward movement, an intake chamber having a volume which varies in response to the forward and backward movement of the first piston, and a work cylinder. A thermal transfer wax is received in the work cylinder, and a second piston is received in the work cylinder and connected to the first piston. The second piston is moved in a temperature-dependent manner via the thermal transfer wax such that the volume of the intake chamber is increased as the temperature rises.

### CROSS-REFERENCES TO RELATED APPLICATIONS

This application claims the priority of European Patent Application, Serial No. 18157884.0, filed Feb. 21, 2018, pursuant to 35 U.S.C. 119(a)-(d), the disclosure of which is incorporated herein by reference in its entirety as if fully set forth herein.

### BACKGROUND OF THE INVENTION

The present invention relates to an oil conveying and storage device for reducing an oil level in a gearbox oil sump during operation of the gearbox. The present invention further relates to a gearbox having an oil sump and an oil conveying and storage device of this kind.

The following discussion of related art is provided to assist the reader in understanding the advantages of the invention, and is not to be construed as an admission that this related art is prior art to this invention.

Different designs of oil-lubricated gearboxes are known from the prior art. They normally include in the lower part of the gearbox casing an oil sump in which oil collects when the gearbox is idle. The oil level in the oil sump is usually selected such that, in idle state, even the smallest gears of the gearbox dip into the oil sump in order to ensure emergency running properties. During operation, due to the movement of the gears in the oil, this results in churning and splashing losses. These differ depending on the direction of rotation and adversely affect the energy balance and thermal behavior, which is basically undesirable.

It would therefore be desirable and advantageous to address these problems and to obviate other prior art shortcomings.

### SUMMARY OF THE INVENTION

According to one aspect of the present invention, an oil conveying and storage device for reducing an oil level in an oil sump of a gearbox during operation of the gearbox includes a first piston mounted for executing a forward and backward movement, an intake chamber having a volume which varies in response to movement of the first piston, a work cylinder, a thermal transfer wax received in the work cylinder, and a second piston received in the work cylinder and connected to the first piston, the second piston being moved in a temperature-dependent manner via the thermal transfer wax such that the volume of the intake chamber is increased as the temperature rises.

According to another aspect of the present invention, a gearbox includes a gearbox casing, an oil sump accommodated inside the gearbox casing, and an oil conveying and storage device for reducing an oil level in the oil sump during operation of the gearbox, the oil conveying and storage device including a first piston mounted for executing a forward and backward movement, an intake chamber having a volume which varies in response to the forward and backward movement of the first piston, an oil line connected to the intake chamber, a work cylinder, a thermal transfer wax received in the work cylinder, and a second piston received in the work cylinder and connected to the first piston, said second piston being moved in a temperature-dependent manner via the thermal transfer wax such that the volume of the intake chamber is increased as the temperature rises, wherein the oil line of the oil conveying and storage device is configured to dip into the oil sump, and wherein the work cylinder is disposed at a position in which the thermal transfer wax is heated by power dissipated during operation of the gearbox.

When arranging an oil conveying and storage device according to the present invention on a gearbox fitted with an oil sump in such a way that an oil line of the oil conveying and storage device dips into the oil sump and the thermal transfer wax is heated by the power dissipated during operation of the gearbox, oil is automatically conveyed from the oil sump into the intake chamber during initial operation of the gearbox as the temperature increases, thereby minimizing churning and splashing losses of the gear box. At the same time, it is also ensured that the level in the oil sump is not reduced until the gearbox has heated up. Reduction of the oil level in the oil sump while the gearbox oil is cold is eliminated. Conversely, oil delivered to the intake chamber is automatically returned to the oil sump as soon as the gearbox cools down due to the thermal transfer wax contracting accordingly, causing oil to be forced out of the intake chamber.

An important advantage of an oil conveying and storage device according to the present invention is that it can operate autonomously without an additional energy source. In addition, orientations of the intake chamber and work cylinder are variable. Thus, the intake chamber and the work cylinder can be mounted both horizontally and vertically, thereby permitting a high degree of flexibility for installing an oil conveying and storage device according to the invention. This is particularly advantageous when an oil conveying and storage device according to the present invention is to be retrofitted to an existing gearbox.

According to another advantageous feature of the present invention, a piston rod can connect the second piston to the first piston.

According to another advantageous feature of the present invention, a spring element can be provided to maintain the first piston under tension in a predetermined direction, in particular in the direction of retraction of the second piston, when in the event the thermal transfer wax cools down, the tractive force of the work cylinder is insufficient to drain the oil present in the intake chamber.

According to another advantageous feature of the present invention, provision can be made for an oil line connected to the intake chamber, a first non-return valve disposed in the oil line, a separate oil drain line connected to the intake chamber, and a second non-return valve disposed in the separate oil drain line. Accordingly, as it is drained from the intake chamber, oil can escape via the oil drain line via which, for example, predetermined components of the gearbox can be supplied with oil.

According to another advantageous feature of the present invention, the oil conveying and storage device can be disposed above the oil sump. This ensures proper filling of the intake chamber as the temperature of the gearbox rises.

According to another advantageous feature of the present invention, the oil conveying and storage device can be disposed inside the gearbox casing. This is space-saving and the gearbox temperature can be transferred directly to the thermal transfer wax, thereby ensuring a good response characteristic of the oil conveying and storage device.

### BRIEF DESCRIPTION OF THE DRAWING

Other features and advantages of the present invention will be more readily apparent upon reading the following description of currently preferred exemplified embodiments of the invention with reference to the accompanying drawing, in which:

FIG. 1 is a schematic view of a first embodiment of a gearbox according to the present invention, depicting the presence of an oil conveying and storage device according to the present invention in a first position;

FIG. 2 is a schematic view of the gearbox shown in FIG. 1, with the oil conveying and storage device assuming a second position;

FIG. 3 is a schematic view of a second embodiment of a gearbox according to the present invention, depicting the presence of an oil conveying and storage device according to the present invention in a first position;

FIG. 4 is a schematic view of the gearbox shown in FIG. 3, with the oil conveying and storage device assuming a second position;

FIG. 5 is a schematic view of a third embodiment of a gearbox according to the present invention;

FIG. 6 is a schematic view of a fourth embodiment of a gearbox according to the present invention, depicting the presence of an oil conveying and storage device according to the present invention in a first position; and

FIG. 7 is a schematic view of the gearbox shown in FIG. 6, with the oil conveying and storage device assuming a second position.

### DETAILED DESCRIPTION OF PREFERRED EMBODIMENTS

Throughout all the figures, same or corresponding elements may generally be indicated by same reference numerals. These depicted embodiments are to be understood as illustrative of the invention and not as limiting in any way. It should also be understood that the figures are not necessarily to scale and that the embodiments may be illustrated by graphic symbols, phantom lines, diagrammatic representations and fragmentary views. In certain instances, details which are not necessary for an understanding of the present invention or which render other details difficult to perceive may have been omitted.

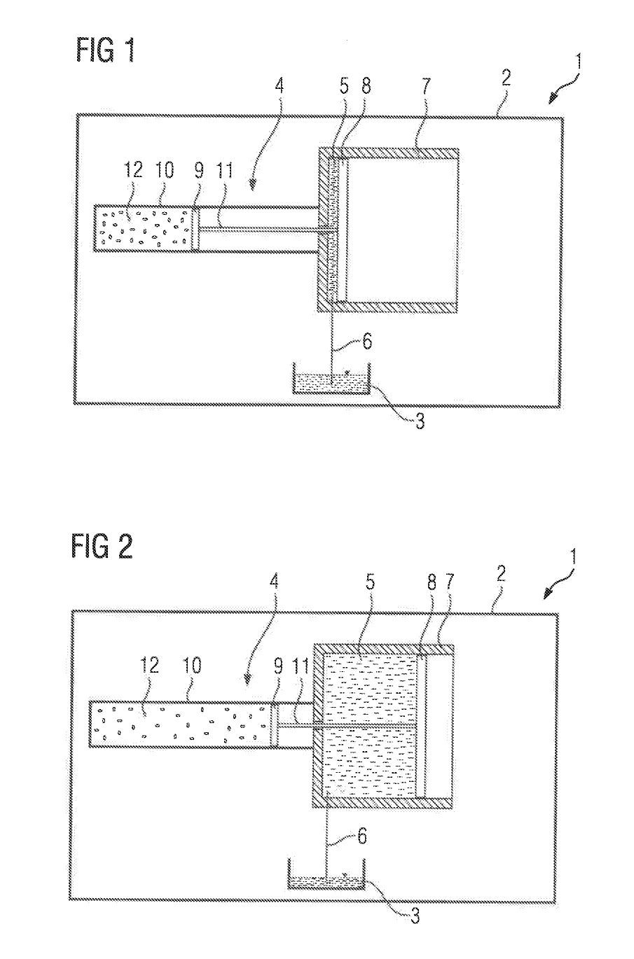

Turning now to the drawing, and in particular to FIG. 1, there is shown a schematic view of a first embodiment of a gearbox according to the present invention, generally designated by reference numeral 1. The gearbox 1 includes a gearbox casing 2 which delimits an oil sump 3 in its lower region. The gearbox 1 also has an oil conveying and storage device 4 which in this case is disposed inside the gearbox casing 2 and is designed to reduce the oil level in the oil sump 3 during operation of the gearbox 1, as will be described in greater detail below. The oil conveying and storage device 4 includes a variable-volume intake chamber 5 to which an oil line 6 fluidically linking the intake chamber 5 to the oil sump 3 is connected. The intake chamber 5 is here delimited by a cylinder housing 7 and piston 8 that can be moved back and forth inside the cylinder housing 7 and forms a fluidic seal with the cylinder housing 7. The oil conveying and storage device 4 also includes a work cylinder 10 having a second piston 9. The work cylinder 10 is fixedly connected at one end to the cylinder housing 7. The second piston 9 is linked to the first piston 8 via a piston rod 11 passing through the cylinder housing 7, and can be moved in a temperature-dependent manner via a thermal transfer wax 12, such that, as the temperature rises, the volume of the intake chamber 5 is increased by displacement of the first piston 8 inside the cylinder housing 7.

FIG. 1 shows a first position of the pistons 8 and 9 of the oil conveying and storage device 4 in a cold state of the gearbox 1 at ambient temperature. In this state the intake chamber 5 has minimum volume, while the oil level in the oil sump 3 is at its maximum. After initial operation of the gearbox 1, the interior of the gearbox casing 2 heats up due to the power dissipation of the gearbox 1. The temperature inside the gearbox casing 2 gradually increases accordingly. This temperature rise also affects the thermal transfer wax 12 which expands as the temperature rises and moves the pistons 8 and 9, enlarging the volume of the intake chamber 5 until a second position, shown in FIG. 2, is reached. Due to the resulting underpressure in the intake chamber 5, oil present in the oil sump 3 is conveyed continuously into the intake chamber 5 via the oil line 6, so that the oil level in the oil sump 3 is reduced accordingly. This minimizes churning and splashing losses during operation of the gearbox 1.

When the gearbox 1 is taken out of operation again, the temperature in the interior of the gearbox casing 2 drops to ambient temperature again. The thermal transfer wax 12 contracts accordingly, so that the pistons 8 and 9 are returned to the position shown in FIG. 1, reducing the volume of the intake chamber 5. The oil present in the intake chamber 5 is therefore also drained back into the oil sump 3 via the oil line 6.

An important advantage of the gearbox 1 described above is that the level in the oil sump 3 is varied in a temperature-dependent manner. The level in the oil sump 3 is only reduced when the temperature inside the gearbox casing 2 increases. This eliminates the possibility of the level being reduced with the gearbox in a cold state. Other advantages conferred by the oil conveying and storage device 4 described above are that it can be operated autonomously without any additional energy source and that the positioning and orientation of the oil conveying and storage device 4 inside the gearbox casing 2 are freely selectable. The oil conveying and storage device 4 merely has to be disposed above the oil sump 3. Accordingly, installation of the oil conveying and storage device 4 inside the gearbox casing 2 is very simple, inexpensive and unproblematic. This also applies to the case of retrofitting the oil conveying and storage device 4 to an existing gearbox 1.

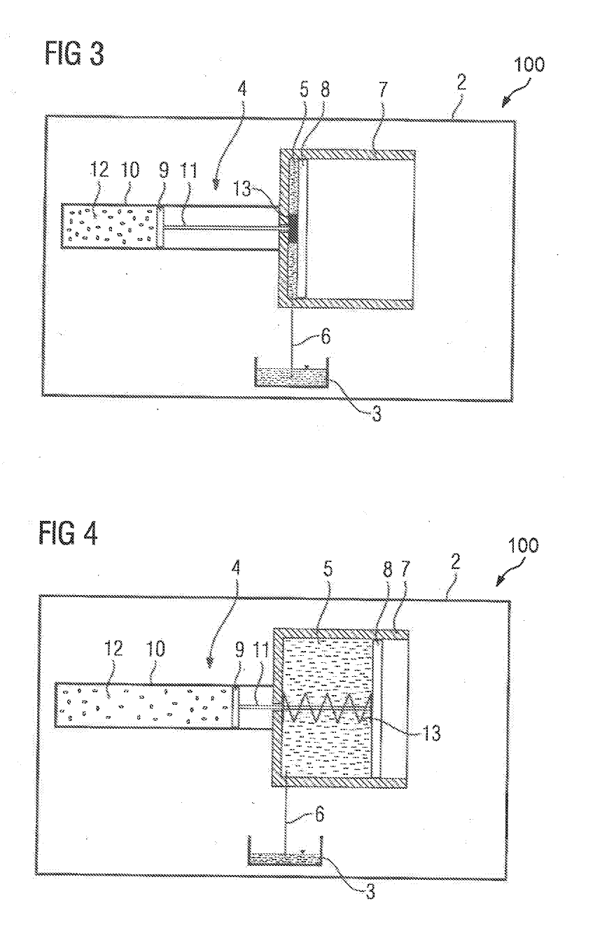

FIGS. 3 and 4 show a second embodiment of a gearbox according to the present invention, generally designated by reference numeral 100, with FIG. 3 corresponding to the first position illustrated in FIG. 1 and FIG. 4 corresponding to the second position illustrated in FIG. 2 of the pistons 8 and 9. Parts corresponding with those in FIGS. 1 and 2 are denoted by identical reference numerals and not explained again. The description below will center on the differences between the embodiments. In this embodiment, provision is made for a spring element 13 to maintain the first piston 8 under tension in a predetermined direction, in this case in the direction of the piston position shown in FIG. 3, so that, as the thermal transfer wax 12 cools, the pistons 8 and 9 are moved by the spring element 13 from the position shown in FIG. 4 back to the position shown in FIG. 3.

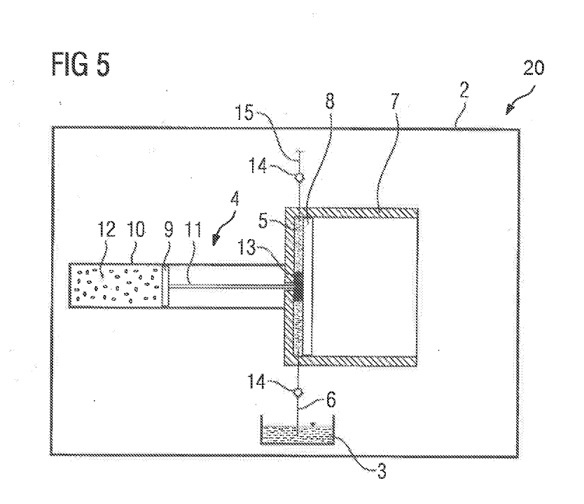

FIG. 5 shows a third embodiment of a gearbox 1 according to the present invention, generally designated by reference numeral 20. The gearbox 20 essentially corresponds to the gearbox 1 shown in FIG. 3. The differences are that the oil line 6 is provided with a non-return valve 14 which prevents oil present in the intake chamber 5 from being able to flow back into the oil sump 3 through the oil line 6. To drain the oil from the intake chamber 5, a separate oil drain line 15 likewise provided with a non-return valve 14 is connected to the intake chamber 5, with the oil drain line 15 leading to lubrication-requiring components (not shown) of the gearbox 20. When the gearbox 20 cools down, these components are then automatically supplied with oil from the intake chamber 5.

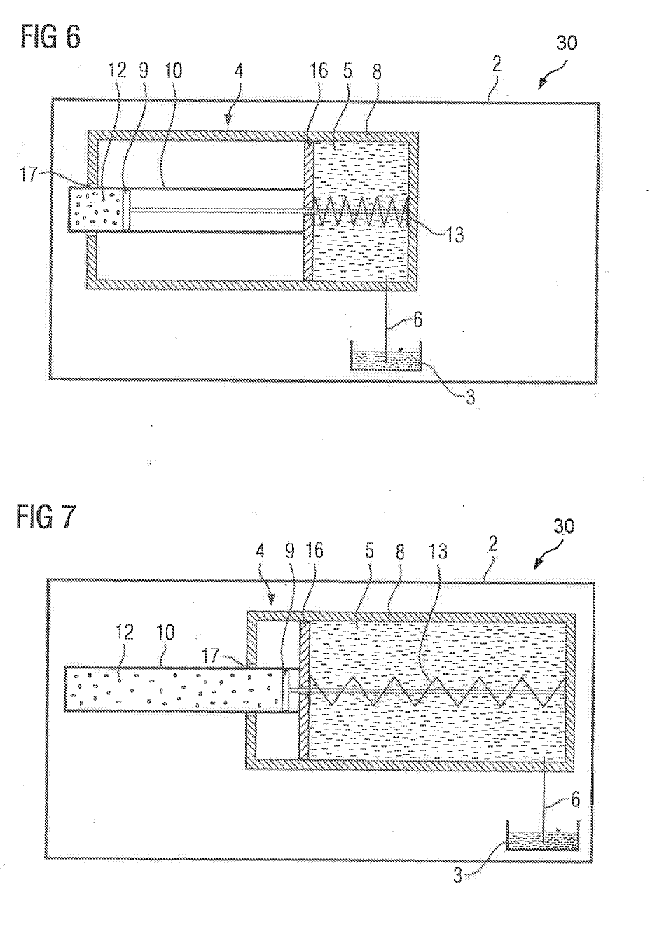

FIGS. 6 and 7 show a fourth embodiment of a gearbox 1 according to the present invention, generally designated by reference numeral 30. The gearbox 30 which, similarly to the embodiments described above, has a gearbox casing 2 including an oil sump 3. The gearbox 30 also includes an oil conveying and storage device 4 having an intake chamber 5 which is connected to the oil sump 3 via an oil line 6. The intake chamber 5 is defined, on one hand, by a piston 8 implemented as a hollow cylindrical annular piston and, on the other hand, by a disk 16 accommodated in a fluid-tight manner in the piston 8 and fluidically sealed with respect to the piston 8. The disk is fixed to the work cylinder 10 and able to move relative to the piston 8. The work cylinder 10 is at least partially accommodated in the piston 8 and in this case passes through an orifice 17 provided on the end of the piston 8 so that it projects outwards from the piston 8. The second piston 9 accommodated inside the work cylinder 10 is connected to the first piston 8 via a piston rod 11 and biased in the direction of the position shown in FIG. 6 via a spring element 13.

When the thermal transfer wax 12 contained in the work cylinder 10 expands due to a rise in temperature inside the gearbox casing 2 of the gearbox 30, the pistons 8 and 9 interconnected via the piston rod 11 are moved from the position shown in FIG. 6 to the position shown in FIG. 7, so that, in the manner described above, oil contained in the oil sump 3 is drawn into the intake chamber 5 via the oil line 6 and the oil level in the oil sump 3 is reduced in a temperature-dependent manner. When the temperature inside the gearbox casing 30 falls again, the contracting thermal transfer waxes 12 and the compressive force of the spring element 13 cause the pistons 8 and 9 to be returned to the position shown in FIG. 6 and the oil contained in the intake chamber 5 to be drained back into the oil sump 3.

While the invention has been illustrated and described in connection with currently preferred embodiments shown and described in detail, it is not intended to be limited to the details shown since various modifications and structural changes may be made without departing in any way from the spirit and scope of the present invention. The embodiments were chosen and described in order to explain the principles of the invention and practical application to thereby enable a person skilled in the art to best utilize the invention and various embodiments with various modifications as are suited to the particular use contemplated. Thus, for example, the gearbox 30 shown in FIGS. 6 and 7 can also be implemented without a spring element 13. Likewise the design shown in FIGS. 6 and 7 can be supplemented by non-return valves 14 and an oil drain line 15 similarly to FIG. 5. It should also be pointed out that the oil conveying and storage device 4 need not necessarily be disposed inside the gearbox casing 2, even though this is advantageous. Likewise, if there is insufficient space inside the gearbox casing 2, it is also possible to position the oil conveying and storage device 4 on the outside of the gearbox casing 2. However, for positioning the oil conveying and storage device 4, it must be ensured that the thermal transfer wax 12 is affected by operationally induced temperature variations of the gearbox in the manner described above, even if there is time delay.

What is claimed as new and desired to be protected by Letters Patent is set forth in the appended claims and includes equivalents of the elements recited therein:

What is claimed is:

1. An oil conveying and storage device for reducing an oil level in an oil sump of a gearbox during operation of the gearbox, said oil conveying and storage device comprising:
a first piston mounted for executing a movement;
an intake chamber having a volume which varies in response to the forward and backward movement of the first piston;
a work cylinder;
a thermal transfer wax received in the work cylinder; and
a second piston received in the work cylinder and connected to the first piston, said second piston being moved in a temperature-dependent manner via the thermal transfer wax such that the volume of the intake chamber is increased as the temperature rises.

2. The oil conveying and storage device of claim 1, further comprising a piston rod connecting the second piston to the first piston.

3. The oil conveying and storage device of claim 1, further comprising a spring element to maintain the first piston under tension in a pre-determined direction.

4. The oil conveying and storage device of claim 1, further comprising:
an oil line connected to the intake chamber;
a first non-return valve disposed in the oil line;
a separate oil drain line connected to the intake chamber; and
a second non-return valve disposed in the separate oil drain line.

5. A gearbox, comprising:
a gearbox casing;
an oil sump accommodated inside the gearbox casing; and
an oil conveying and storage device for reducing an oil level in the oil sump during operation of the gearbox, said oil conveying and storage device comprising a first piston mounted for executing a forward and backward movement, an intake chamber having a volume which varies in response to the forward and backward movement of the first piston, an oil line connected to the intake chamber, a work cylinder, a thermal transfer wax received in the work cylinder, and a second piston received in the work cylinder and connected to the first piston, said second piston being moved in a temperature-dependent manner via the thermal transfer wax such that the volume of the intake chamber is increased as the temperature rises, said oil line of the oil conveying and storage device configured to dip into the oil sump,
wherein the work cylinder is disposed at a position in which the thermal transfer wax is heated by power dissipated during operation of the gearbox.

6. The gearbox of claim 5, wherein the oil conveying and storage device includes a piston rod connecting the second piston to the first piston.

7. The gearbox of claim 5, wherein the oil conveying and storage device is disposed above the oil sump.

8. The gearbox of claim 5, wherein the oil conveying and storage device is disposed inside the gearbox casing.
